(19) United States
(12) Patent Application Publication
(10) Pub. No.: US 2012/0306607 A1
(43) Pub. Date: Dec. 6, 2012

(54) CHIP-TYPE COIL COMPONENT

(75) Inventors: Dong Jin JEONG, Suwon (KR); Jin Ho KU, Suwon (KR)

(73) Assignee: Samsung Electro-Mechanics Co., Ltd.

(21) Appl. No.: 13/466,811

(22) Filed: May 8, 2012

(30) Foreign Application Priority Data
May 31, 2011 (KR) 10-2011-0052281

(51) Int. Cl. H01F 27/29

(52) U.S. Cl. 336/192

(57) ABSTRACT

There is provided a chip-type coil component, including: a body formed by laminating a plurality of magnetic layers; external terminals formed on a surface of the body provided as a mounting surface among external surfaces of the body; a coil part including conductor patterns having a spiral structure in a lamination direction of the magnetic layers, the conductor patterns respectively formed on the magnetic layers; and lead-out parts formed in the lamination direction of the magnetic layers, and electrically connecting ends of the coil part and the external terminals, wherein the lead-out parts each include via conductors formed by penetrating the magnetic layers and via pads covering the via conductors while central lines of via conductors formed in adjacent magnetic layers are offset from each other.

### CROSS-REFERENCE TO RELATED APPLICATIONS

This application claims the priority of Korean Patent Application No. 10-2011-0052281 filed on May 31, 2011, in the Korean Intellectual Property Office, the disclosure of which is incorporated herein by reference.

### BACKGROUND OF THE INVENTION

1. Field of the Invention

The present invention relates to a chip-type coil component, and more particularly, to a chip-type coil component having excellent reliability.

2. Description of the Related Art

With the recent trend for the miniaturization, slimming, and lightening of electronic components, demand for laminated-type electronic components is rapidly increasing.

A laminated-type inductor includes a body formed by laminating a plurality of magnetic layers, external terminals formed on an external surface of the body, a coil part formed inside the body, and the like.

When the laminated-type inductor is mounted on a substrate, external terminals may be formed on a lower surface in consideration of ease of surface-mountability and the like.

In this case, via conductors are arranged in a straight line, to allow for an electrical connection to be formed between the coil part and the external terminals.

The via conductor is formed by filling a via hole with a conductive paste, which is subsequently fired.

In general, the conductive paste used to form the via conductor has pores present therein. These pores are removed during a firing procedure, followed by a conductive metal powder densification procedure, and thus, the via conductor may shrink.

When the via conductors are arranged in a straight line, electrical connections between the via conductors may be cut, due to firing shrinkage of the via conductors.

Moreover, electrical connectivity between the via conductors may be cut, even in the case that the via conductors entirely deviate from the straight line.

### SUMMARY OF THE INVENTION

An aspect of the present invention provides a chip-type coil component having excellent reliability.

According to an aspect of the present invention, there is provided a chip-type coil component, including: a body formed by laminating a plurality of magnetic layers; external terminals formed on a surface of the body provided as amounting surface among external surfaces of the body; a coil part including conductor patterns having a spiral structure in a lamination direction of the magnetic layers, the conductor patterns respectively formed on the magnetic layers; and lead-out parts formed in the lamination direction of the magnetic layers, and electrically connecting ends of the coil part and the external terminals, wherein the lead-out parts each include via conductors formed by penetrating the magnetic layers and via pads covering the via conductors while central lines of via conductors formed in adjacent magnetic layers are offset from each other.

A distance between the central lines of the via conductors formed in the adjacent magnetic layers may be 50 μm or greater, and a spacing distance between the via conductors may be 50 μm or less.

The via conductors may be arranged in zigzag patterns.

The via pad may be rectangular or circular, and a length or a diameter of the via pad may be greater than a value obtained by adding 50 μm to a value equal to two times a length or a diameter of the via conductor, but smaller than half of a length of the chip-type coil component.

The via conductor may have a truncated cone shape, becoming thinner from an end of the coil part toward the external terminal.

The via conductors may be arranged to have a spiral structure.

The via conductors may include four via conductors as a single turn of the spiral structure.

The via pad may have a rectangular shape, and a width of the via pad may be greater than a value obtained by adding 50 μm to a value equal to two times a length or a diameter of the via conductor, but smaller than half of a length of the chip-type coil component.

The via pad may have a circular shape, and a diameter of the via pad may be greater than a value obtained by adding 71 μm to a value equal to two-and-a-half times a length or a diameter of the via conductor, but smaller than half of a length of the chip-type coil component.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view of a chip-type coil component according to an embodiment of the present invention;

FIG. 2 is a cross-sectional view taken along line A-A′ of FIG. 1; and

FIGS. 3A through 4C are projection views obtained by projecting Portion B of FIG. 2 taken along line A-A′ (FIGS. 3A and 4A) and projection views in a lamination direction of magnetic layers (FIGS. 3B, 3C, 4B, and 4C).

### DETAILED DESCRIPTION OF THE INVENTION

Embodiments of the present invention will now be described in detail with reference to the accompanying drawings.

The invention may, however, be embodied in many different forms and should not be construed as being limited to the embodiments set forth herein. The embodiments of the present invention are provided so that those skilled in the art may more completely understand the present invention.

In the drawings, the shapes and dimensions of components may be exaggerated for clarity, and the same reference numerals will be used throughout to designate the same or like components.

A chip-type coil component is an electronic component including a coil part. There may be a laminated-type inductor only functioning as an inductor in this kind of the chip-type coil component. The coil part may be formed in a portion of the component and another component such as a capacitor may be formed in another portion of the component.

The laminated-type inductor is exemplified in the present invention, but the present invention is not limited thereto.

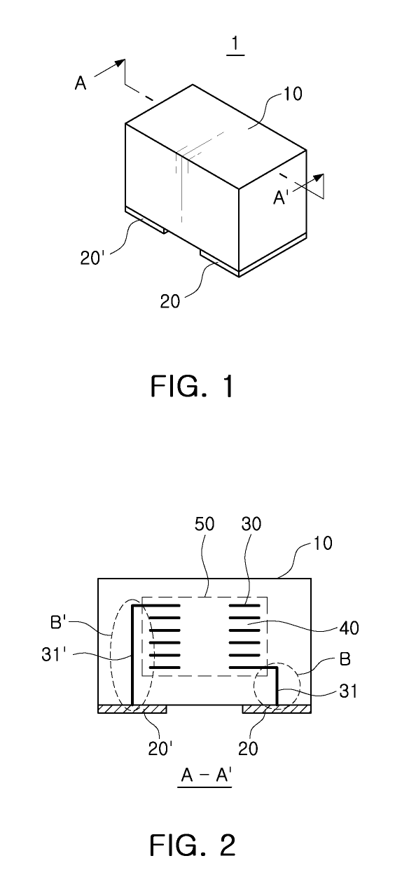

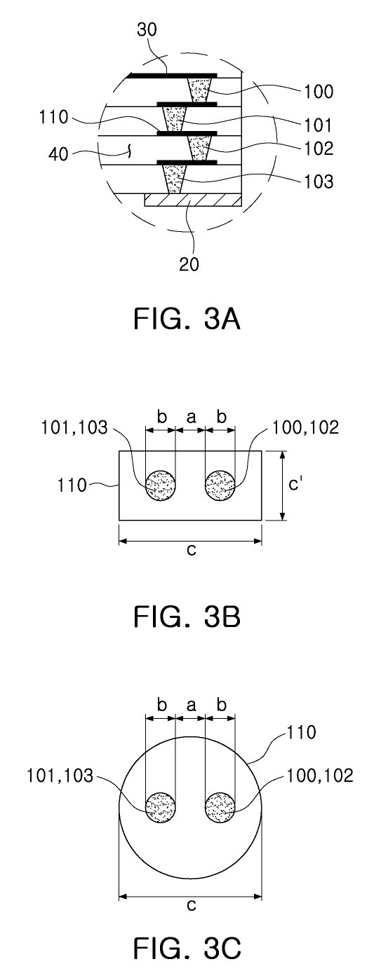

FIG. 1 is a perspective view of a chip-type coil component according to one embodiment of the present invention; and FIG. 2 is a cross-sectional view taken along line A-A′ of FIG. 1.

Referring to FIGS. 1 and 2, a chip-type coil component 1 according to an embodiment of the present invention may include a body 10 formed by laminating a plurality of magnetic layers 40; external terminals 20 and 20′ formed on a surface of the body provided as a mounting surface among external surfaces of the body 10; a coil part 50 including conductor patterns 30 having a spiral structure in a lamination direction of the magnetic layers 40, the conductor patterns 30 being formed on the respective magnetic layers 40; and lead-out parts 31 and 31′ formed in the lamination direction of the magnetic layers 40, and electrically connecting ends of the coil part 50 and the external terminals 20 and 20′, wherein the lead-out parts 31 and 31′ each include via conductors 100 to 103 respectively penetrating the magnetic layers 40 and via pads 110 respectively covering the via conductors 100 to 103 while central lines of the via conductors formed in adjacent magnetic layers are offset from each other.

The body 10 may be formed by laminating the plurality of magnetic layers 40.

A magnetic slurry is prepared by mixing a magnetic powder such as a nickel-zinc-copper ferrite or the like with a solvent such as ethanol or the like, adding a binder such as PVA or the like, a plasticizer, or the like, thereto, and then mixing and dispersing the elements through a ball milling method or the like. The magnetic slurry may be printed on a film such as PET or the like through a doctor blade method or the like, to form a magnetic layer.

The plurality of the magnetic layers 40 may be laminated to form the body 10.

The external terminals 20 and 20′ may be formed on a surface of the body 10 provided as a mounting surface, among external surfaces of the body 10.

When both the external terminals 20 and 20′ are formed on the mounting surface, surface mounting may be performed even without an additive structure.

The external terminals 20 and 22′ may include a conductive metal such as copper or the like as a main component and a glass frit or the like as a sub-component.

The external terminals 20 and 20′ may be formed by a dipping method, and a tinplating layer may be generally formed on each of the external terminals 20 and 20′.

The coil part 50 may have a spiral structure in the lamination direction of the magnetic layers 40, by the conductor patterns 30 respectively formed on the magnetic layers 40.

The conductor patterns 30 may be formed by using a conductive paste, prepared by mixing a conductive metal such as nickel or the like, a dispersant, a plasticizer, and the like with a solvent and performing ball milling or the like.

The conductor patterns 30 may be respectively formed on the magnetic layers 40 through a screen printing method or the like.

The conductor patterns 30 may be formed to have various shapes, and the conductor patterns 30 may be connected by a via conductor (not shown).

Via conductors (not shown) may be formed by filling via holes, formed by penetrating the magnetic layers 40, with a conductive paste.

Through this connection, the coil part 50 may generally be formed to have a spiral structure in the lamination direction of the magnetic layers 40.

As such, the coil part 50 has the spiral structure, and thus, the electronic component may function as an inductor.

The lead-out parts 31 and 31′ each may include the via conductors respectively penetrating the magnetic layers 40 and the via pads respectively covering the via conductors. The central lines of the via conductors formed in the adjacent magnetic layers may not be aligned.

Here, the central line of the via conductor means a virtual line extended in the lamination direction of the magnetic layers 40 passing through the center of gravity of the via conductor, on a projection view taken in the lamination direction of the magnetic layers.

In a case in which the central lines of the via conductors, respectively formed in the adjacent magnetic layers, are aligned, electrical disconnection may occur.

A small amount of shrinkage may occur in the via conductors at the time of firing, although it depends on the composition of the conductive paste used in forming the via conductors.

In the case in which the via conductors are arranged such that the central lines of the via conductors are aligned, firing shrinkages of the respective via conductors may be combined with each other to lead to synergistic effect, in consideration of all the laminated via conductors even in the case that the shrinkage amount of each via conductor is small.

When the firing shrinkage amount of the laminated via conductors reaches a critical point, an electrical connection may be cut in some of the laminated via conductors. This is referred to as ‘via omission’.

However, in the case in which the central lines of the via conductors, respectively formed in the adjacent magnetic layers, are offset from each other, firing shrinkage may occur in one of the laminated via conductors but may have little influence on the other via conductors.

In other words, firing shrinkage may occur in each of the via conductors, but does not necessarily lead to a synergistic effect with regard to firing shrinkage in all the via conductors, and thus, a via omission phenomenon may not occur.

The fact that the central lines of the via conductors formed in the adjacent magnetic layers are offset from each other may have the following meanings.

First, the central lines of the via conductors formed in non-adjacent magnetic layers may be aligned.

For example, in the case in which first to third magnetic layers are adjacent to one another, a central line of the via conductor formed in the first magnetic layer is not aligned with a central line of the via conductor formed in the second magnetic layer, but the central line of the via conductor formed in the first magnetic layer may be aligned with a central line of the via conductor formed in the third magnetic layer.

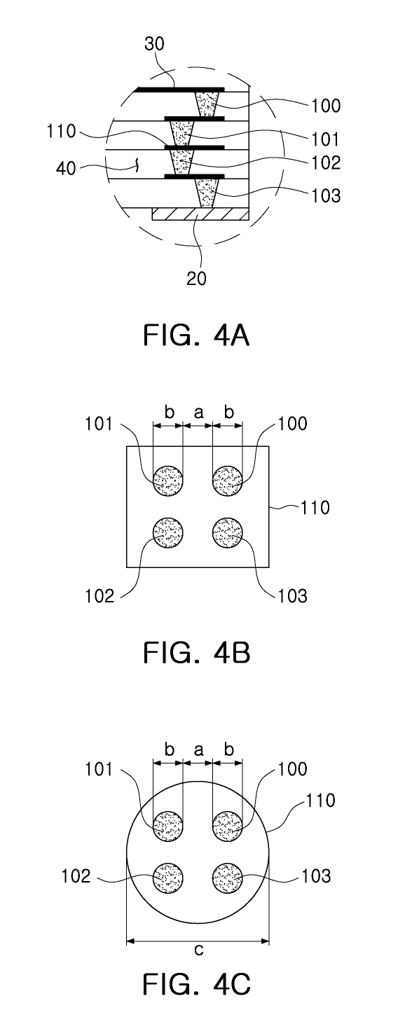

An example thereof may correspond to a case in which via conductors are arranged in zigzag patterns in the lamination direction of the magnetic layers, which will be later described with reference to FIGS. 3A through 3C.

Second, only if the central lines of the via conductors formed in the adjacent magnetic layers are offset from each other, the via conductors formed in the magnetic layers, adjacent upwardly and downwardly when projected in the lamination direction of the magnetic layers, may partially overlap each other.

A distance between the central lines of the via conductors formed in the adjacent magnetic layers may be 50 μm or greater, and a spacing distance between the via conductors may be 50 μm or less.

When the distance between the central lines of the via conductors formed in the adjacent magnetic layers is 50 μm or less, an electrical connection between the via conductors may be cut due to shrinkage of the via conductors at the time of firing since an overlapping area between the via conductors is wide.

When the spacing distance between the via conductors formed in the adjacent magnetic layers is 50 μm or greater, an area of the via pad may be excessively increased, and a conductive passage formed by the via conductors and the via pads is lengthened, which may cause an excessive increase in electrical resistance.

Here, the spacing distance means a shortest distance between via conductors, which do not overlap each other and are separated from each other when the via conductors formed in the adjacent magnetic layers are projected in the lamination direction of the magnetic layers.

The lead-out parts 31 and 31′ may electrically connect the ends of the coil part 50 and the external terminals 20 and 20′.

Current flows to one external terminal from the outside, and current flows out from the other external terminal to the outside.

The lead-out parts 31 and 31′ will be described with reference to FIGS. 3A through 4C.

For convenience, a case in which via conductors formed in adjacent magnetic layers are spaced apart from each other will be described as an example in FIGS. 3A through 3C, but the present invention is not limited thereto.

FIG. 3A is a projection view (a) obtained by projecting Portion B of FIG. 2 taken along line A-A′.

For convenience, Portion B of one lead-out part 31 will be described, but Portion B′ of the other lead-out part 31′ is identical thereto, except for a difference therebetween in that the lead-out part 31′ is longer than the lead-out part 31.

FIGS. 3B and 3C are projection views taken along the lamination direction of the magnetic layers. FIG. 3B shows a rectangular via pad and FIG. 3C shows a circular via pad.

Referring to FIG. 3A, the via conductors 100 to 103 may be spaced apart from each other in zigzag patterns. That is, the lead-out part 31 may be formed by repeatedly laminating via conductor units, two via conductors 100 and 101 being a single unit. However, central lines of the via conductors 100 and 102 formed in non-adjacent magnetic layers may be aligned.

As such, the central lines of the via conductors 100 and 101 formed in the adjacent magnetic layers are not aligned, thereby preventing shrinkage of the via conductors occurring at the time of firing, and preventing electrical disconnection due to the firing shrinkage.

In the case in which the central lines of the via conductors 100 and 101 formed in the adjacent magnetic layers are aligned, an electrical disconnection between the via conductors may occur due to shrinkage of the via conductors in the firing procedure. However, this defect may be prevented in the present embodiment.

The via conductors 100 to 103 each may have a truncated cone shape becoming thinner from an end of the coil part 50 toward the external terminal 20.

When the via conductors 100 to 103 each have a truncated cone shape, a contact area between each of the via conductors 100 to 103 and the magnetic layer 40 may be increased, and thus, adhesive strength between the via conductors 100 to 103 and the magnetic layers 40 may be excellent.

An upper surface of each of the truncated cone shaped via conductors 100 to 103 may be disposed toward the external terminal 20 from the coil part.

In this case, the upper surface of the truncated cone shaped via conductor 100 may be spaced apart from a lower surface of the truncated cone shaped via conductor 101 formed in an adjacent lower magnetic layer.

In the truncated cone shape, a large diameter surface is referred to as the lower surface, and a small diameter surface is referred to as the upper surface.

The via pads 110 may each cover the via conductors 100 and 101 formed in the adjacent magnetic layers.

The via pad 110 may be widened to cover the via conductors 100 and 101 formed in the adjacent magnetic layers, and thus a sufficient electrical connection occurs through the via pad 110, thereby preventing an electrical disconnection, even in the case that a direct electrical connection does not occur between the via conductors 100 and 101 formed in the adjacent magnetic layers due to alternating arrangement of the via conductors.

The via pad 110 may be formed to be square or circular.

The via pad 110 may be formed to have a polygonal shape, an oval shape, or the like.

The length (or diameter) of the via pad 110 is sufficient as long as it covers the via conductors 100 to 103, and the shape of the via pad is not particularly limited.

FIG. 3B shows a case in which the via pad 110 is square.

A length (c) of the via pad 110 may be greater than a value obtained by adding 50 μm to a value of two times a diameter (b) of the via conductor, but smaller than half of a length of the chip-type coil component.

The length (c) of the via pad may be determined as follows.

That is, since the distance between the central lines of the via conductors 100 and 101 formed in the adjacent magnetic layers is 50 μm or more and the spacing distance between the via conductors is 50 μm or less, the via pad needs to be larger as compared with a case in which the spacing distance between the via conductors is 50 μm.

When the spacing distance between the via conductors is 50 μm, the maximum length of the via pad may be a value obtained by adding 50 μm to a value of two times the diameter (b) of the via conductor.

Therefore, the length of the via pad may be larger than the value obtained by adding 50 μm to the value of two times the diameter (b) of the via conductor.

However, in a case in which the via conductors 100 and 101 formed in the adjacent magnetic layers are not arranged in zigzag patterns, a width (c′) of the via pad does not need to be larger than a value of two times the diameter (b) of the via conductor, but is sufficient as long as it is larger than the diameter (b) of the via conductor.

In a case in which the length of the via pad is larger than half of the length of the chip-type coil component, the via pads formed in the lead-out part 31 may be in contact with the via pads formed in the lead-out part 31′. Therefore, the length of the via pad needs to be smaller than half of the length of the chip-type coil component.

FIG. 3C shows a case in which the via pad 110 has a circular shape.

A diameter (c) of the via pad may be greater than a value obtained by adding 50 μm to a value of two times the diameter (b) of the via conductor but smaller than half of the length of the chip-type coil component.

A numerical range of the diameter (c) of the via pad is the same as described above.

In a case in which the via pad 110 has an oval shape, the diameter of the via pad 110 may be properly regulated so that the via pads 110 cover the via conductors 100 to 103.

In the present embodiment, the via conductors 100 to 103 may be arranged to have a spiral structure.

Hereinafter, the spiral structure of the via conductors will be described with reference to FIGS. 4A through 4C.

For convenience, a case in which via conductors formed in adjacent magnetic layers are spaced apart from each other will be described as an example below, but the present invention is not limited thereto.

FIG. 4A is a projection view (a) obtained by projecting Portion B of FIG. 2 taken along line A-A′.

For convenience, Portion B of one lead-out part 31 will be described, but Portion B′ of the other lead-out part 31′ is identical thereto, except for a difference therebetween in that the lead-out part 31′ is longer than the lead-out part 31.

FIGS. 4B and 4C are projection views taken in the lamination direction of the magnetic layers. FIG. 4B shows a square via pad and FIG. 4C shows a circular via pad.

Referring to FIG. 4A, four via conductors 100 to 103 may be arranged to have a spiral structure.

That is, the four via conductors 100 to 103 may be a single unit so as to constitute a single turn of the spiral structure.

A first via conductor 100 may be connected to the terminal of the coil part 50.

A second via conductor 101 may be formed in an adjacent lower magnetic layer of the first via conductor 100. The second via conductor 101 may be spaced apart from the first via conductor 100 so as not to overlap with the first via conductor 100. An electrical connection between the first via conductor 100 and the second via conductor 101 may be maintained by the via pad 110.

A third via conductor 102 may be formed in an adjacent lower magnetic layer of the second via conductor 101, and may be spaced apart from a virtual extension line connecting the first and second via conductors 100 and 101 in a width direction. An electrical connection between the second via conductor 101 and the third via conductor 102 may be maintained by the via pad 110.

A fourth via conductor 103 may be formed in an adjacent lower magnetic layer of the third via conductor 102, and may be spaced apart from a virtual extension line connecting the second and third via conductors 101 and 102 in a length direction. An electrical connection between the third via conductor 102 and the fourth via conductor 103 may be maintained by the via pad 110.

A single turn of the spiral structure may reach from the first via conductor 100 to the fourth via conductor 104.

The first to fourth via conductors may be arranged in a square shape when viewed in the lamination direction of the magnetic layers.

A lead-out part may be formed by laminating a single turn of the spiral structure.

The first to fourth via conductors 100 to 103 are spaced apart from each other, but an electrical connection therebetween may be maintained by the via pads 110.

In order to maintain an electrical connection between the first to fourth via conductors 100 to 103, the length (or diameter) of the via pad may be sufficiently large to cover an arrangement of the via conductors.

FIG. 4B shows a case in which the via pad has a rectangular shape.

A width (c) of the via pad may be greater than a value obtained by adding 50 μm to a value equal to two times the diameter (b) of the via conductor, but smaller than half of the length of the chip-type coil component.

The limitation that the width (c) of the via pad is greater than a value obtained by adding 50 μm to a value equal to two times the diameter (b) of the via conductor is due to the facts that the distance between the central lines of the via conductors formed in the adjacent magnetic layers is 50 μm or more and the spacing distance between the via conductors is 50 μm or less.

A detailed description thereof will be the same as described above.

In a case in which the length of the via pad is larger than half of the length of the chip-type coil component, the via pads formed in the lead-out part 31 may be in contact with the via pads formed in the lead-out part 31′.

In a case in which the via pad 110 has a polygonal shape other than a rectangular shape, the length of the via pad 110 may be properly adjusted so that the via pads 110 cover the via conductors 100 to 103.

FIG. 4C shows a case in which the via pad has a circular shape.

The diameter of the via pad may be greater than a value obtained by adding 71 μm to a value of two-and-a-half times the diameter (b) of the via conductor but smaller than half of the length of the chip-type coil component.

The diameter of the via pad may be greater than a value obtained by adding 71 μm to a value of two-and-a-half times the diameter of the via conductor.

This is due to the fact that the distance between the central lines of the via conductors formed in the adjacent magnetic layers is 50 μm or greater and the spacing distance between the via conductors is 50 μm or less.

That is, even in the case that the via conductors are arranged to have maximal spacing therebetween, the via pads need to cover the via conductors. Therefore, the diameter of the via pad may be determined in consideration of the maximal spacing in the arrangement of the via conductors.

In a case in which the four via conductors are spaced apart from each other at intervals of 50 μm, the spacing therebetween may be maximized.

The diameter of the via pad for covering all via conductors may have a value obtained by adding 70.7 μm to 2.414 times the diameter (b) of the via conductor.

In order to sufficiently include the above diameter value, the diameter of the via pad may be set to a value obtained by adding 71 μm to a value of two-and-a-half times the diameter of the via conductor.

In a case in which the via pad 110 has an oval shape, the diameter of the via pad may be properly adjusted so that the via pads 110 cover the via conductors 100 to 103.

A detailed description regarding a distance between the via conductors and a truncated cone shape of the via conductors is the same as described above.

In the present embodiment, the four via conductors 100 to 103 are formed as a single unit and have a spiral structure. However, the present invention is not limited thereto. Three via conductors, five via conductors, six via conductors, or the like, may be formed as a single unit having a spiral structure, provided that the via conductors do not overlap.

For example, when six via conductors are formed as a single unit having a spiral structure, the via conductors may be formed in adjacent magnetic layers with an angle of 60 degrees therebetween.

Hereinafter, a method of manufacturing a chip-type coil component will be described.

Each magnetic layer 40 may be formed by using a nickel-zinc-copper based ferrite powder exhibiting high permeability.

Specifically, a magnetic slurry may be prepared by mixing the ferrite powder with a solvent, adding a binder, a plasticizer, a dispersant, and the like thereto, mixing the resultant slurry with a ball mill, and then performing defoamation while reducing a pressure.

A magnetic green sheet may be produced by forming the magnetic slurry into a sheet using a doctor blade method or the like, followed by drying.

Via conductors 100 to 103 may be formed by providing via holes in the magnetic green sheets using a laser, and then filling the via holes with a conductive paste including Ag, Pd, Cu, Au, Ni, or an alloy thereof as a main component.

Via pads 110 may be formed by using a conductive paste, as in the case of the via conductors 100 to 103.

Conductor patterns 30 may be formed on the magnetic green sheets, respectively, by using a Ni conductive paste through a screen printing method.

Pure magnetic layers, magnetic layers having via conductors and via pads, magnetic layers having conductor patterns and via conductors, and the like may be laminated, followed by compressing, cutting, and firing processes.

External terminals 20 and 20′ may be formed on an external surface of the body 10 by using a conductive paste containing cupper as a main component through a dipping method or the like.

A plating layer may be formed on the external terminals 20 and 20′, and a tin plating layer may mainly be used.

As set forth above, according to embodiments of the present invention, a chip-type coil component having excellent reliability can be obtained by connecting a coil part and external terminals using via conductors and via pads.

While the present invention has been shown and described in connection with the exemplary embodiments, it will be apparent to those skilled in the art that modifications and variations can be made without departing from the spirit and scope of the invention as defined by the appended claims.

What is claimed is:

1. A chip-type coil component, comprising:
a body formed by laminating a plurality of magnetic layers;
external terminals formed on a surface of the body provided as a mounting surface among external surfaces of the body;
a coil part including conductor patterns having a spiral structure in a lamination direction of the magnetic layers, the conductor patterns respectively formed on the magnetic layers; and
lead-out parts formed in the lamination direction of the magnetic layers, and electrically connecting ends of the coil part and the external terminals,
wherein the lead-out parts each include via conductors formed by penetrating the magnetic layers and via pads covering the via conductors while central lines of via conductors formed in adjacent magnetic layers are offset from each other.

2. The chip-type coil component of claim 1, wherein a distance between the central lines of the via conductors formed in the adjacent magnetic layers is 50 μm or greater, and
a spacing distance between the via conductors is 50 μm or less.

3. The chip-type coil component of claim 1, wherein the via conductors are arranged in zigzag patterns.

4. The chip-type coil component of claim 3, wherein the via pad is rectangular or circular, and
a length or a diameter of the via pad is greater than a value obtained by adding 50 μm to a value equal to two times a length or a diameter of the via conductor, but smaller than half of a length of the chip-type coil component.

5. The chip-type coil component of claim 1, wherein the via conductor has a truncated cone shape, becoming thinner from an end of the coil part toward the external terminal.

6. The chip-type coil component of claim 1, wherein the via conductors are arranged to have a spiral structure.

7. The chip-type coil component of claim 6, wherein the via conductors comprises four via conductors as a single turn of the spiral structure.

8. The chip-type coil component of claim 7, wherein the via pad has a rectangular shape, and
a width of the via pad is greater than a value obtained by adding 50 μm to a value equal to two times a length or a diameter of the via conductor, but smaller than half of a length of the chip-type coil component.

9. The chip-type coil component of claim 7, wherein the via pad has a circular shape, and
a diameter of the via pad is greater than a value obtained by adding 71 μm to a value equal to two-and-a-half times a length or a diameter of the via conductor, but smaller than half of a length of the chip-type coil component.
